(19) United States
(12) Patent Application Publication
(10) Pub. No.: US 2016/0306782 A1
(43) Pub. Date: Oct. 20, 2016

(54) METHOD AND APPARATUS FOR SHARING COMMON DOCUMENTS USING DUALIZED SERVER

(71) Applicant: Infraware Inc., Seoul (KR)

(72) Inventor: Jong Deok JANG, Seoul (KR)

(21) Appl. No.: 14/839,391

(22) Filed: Aug. 28, 2015

(30) Foreign Application Priority Data
Apr. 20, 2015 (KR) 10-2015-0055170

(51) Int. Cl. G06F 17/24; H04L 29/08

(52) U.S. Cl. CPC G06F 17/24; H04L 67/1097

(57) ABSTRACT

The present disclosure relates to a method and an apparatus for sharing common documents using a dualized server. The method of sharing common documents using a dualized server according to an embodiment of the present disclosure includes: providing a common document file to a document edit terminal; receiving edit instructions for editing the common document file from the document edit terminal; keeping the edit instructions, which are received until an updating condition for updating the common document file is satisfied, sequentially on an edit instruction list; and updating the common document file on the basis of the common document file and the edit instruction list through an engine for updating the common document file, when the updating condition is satisfied. Further, the method and the apparatus can rapidly edit common document shared by a plurality of document edit terminals, using a small amount of resources.

### CROSS-REFERENCE TO RELATED APPLICATIONS

This application claims the priority of Korean Patent Application No. 10-2015-0055170 filed on Apr. 20, 2015, in the Korean Intellectual Property Office, the disclosure of which is incorporated herein by reference.

### BACKGROUND

1. Field

The present disclosure relates to a method and an apparatus for sharing common documents using a dualized server, and more particularly, to a method and an apparatus for sharing common documents using a dualized server that has a small amount of resources and can quickly edit common documents.

2. Description of the Related Art

Recently, various services are provided through the internet with development of the communication technology. In particular, big files are transferred and a large amount of data is transmitted and received through the internet. Accordingly, through internet, technology of sharing various files whenever and wherever a person needs has been developed.

The cloud service allows users who use terminals to keep data or files in a virtual storage and exchange and share data or files through the virtual storage on the basis of various communication technologies (for example, the internet). Users can freely use data or files through the cloud service. In detail, users can download or upload data or files without restrictions on time and space and share data or files with other users through the cloud service.

The cloud service is based on a cloud server that is a virtual storage for keeping and sharing data or files. In detail, users can keep and share document files through a cloud server and can edit document files from their terminals. In particular, users can simultaneously share and edit document files by connecting with a cloud server.

However, when users edit common documents shared by their terminals, a cloud server may include an engine that applies edited contents to the common documents in the terminals in the process of applying the edited things to the common documents and sharing them. Accordingly, when the number of terminals sharing common documents through a cloud server increases, the number of engines for applying edited things to the common documents may increase. Further, the number of resources used in proportion to the number of document editing terminals for sharing and editing the common document may also increase. That is, when the number of terminals sharing common document increases, there may be an increase in the load for applying edited things to the common documents through the cloud server. Also, performance and quality of the cloud server may be deteriorated.

Accordingly, it has been increasingly required to provide a method of sharing common documents using a dualized server in order to reduce a load on a server, which provides common documents to be shared and edited, and efficiently share and edit the common documents.

### SUMMARY

An object of the present disclosure is to provide a method and an apparatus for sharing common documents using a dualized server that can rapidly edit documents (hereafter, referred to as common documents) made by collaboration of a plurality of document edit terminals, using a small amount of resources.

Another object of the present disclosure is to provide a method and an apparatus for sharing common documents using a dualized server. This dualized server can quickly provide updated common documents to document edit terminals that additionally share common documents, when common documents are shared by additional document edit terminals.

It should be noted that objects of the present disclosure are not limited to the above-mentioned object and other objects of the present disclosure will be apparent to those skilled in the art from the following descriptions.

According to an aspect of the present disclosure to achieve the above-described objects, there is provided a method of sharing common documents using a dualized server that includes: providing a common document file to a document edit terminal; receiving edit instructions for editing the common document file from the document edit terminal; storing the edit instructions, which are received until an updating condition for updating the common document file is satisfied, sequentially on an edit instruction list; and updating the common document file on the basis of the common document file and the edit instruction list through an engine for updating the common document file, when the updating condition is satisfied.

According to another feature of the present disclosure, the method further includes receiving the common document file from a shared server.

According to yet another feature of the present disclosure, the edit instructions include a instruction for changing, deleting, or adding at least a portion of the common document file.

According to still another feature of the present disclosure, the updating condition corresponds to a case in which the size of the edit instruction list is equal to or larger than the size of a predetermined stack. Or, the updating condition may correspond to a case in which a predetermined updating time for updating the common document file is passed.

According to still another feature of the present disclosure, the method further includes transmitting an updated common document file to the document edit terminal.

According to still another feature of the present disclosure, the transmitting of an updated common document file to the document edit terminal includes transmitting the updated common document file to an additional document edit terminal, when the additional document edit terminal requests sharing the common document file.

According to another aspect of the present disclosure to achieve the above-described objects, there is provided an apparatus for sharing common documents using a dualized server that includes: an engine-pool server including an engine for updating a common document file; and a instruction transmission server transmitting instructions to the engine-pool server, in which the engine-pool server provides the common document file to the document edit terminal and updates the common document file on the basis of the common document file and the edit instruction list through an engine for updating the common document file, when an updating condition for updating the common document file is satisfied, and the instruction transmission server receives edit instructions for editing the common document file from the document edit terminal and stores the edit instructions, which are received until the updating condition is satisfied, sequentially on an edit instruction list.

According to another feature of the present disclosure, the engine-pool server receives the common document file from a shared server.

According to yet another feature of the present disclosure, the edit instructions include a instruction for changing, deleting, or adding at least a portion of the common document file.

According to still another feature of the present disclosure, the updating condition corresponds to a case in which the size of the edit instruction list is equal to or larger than the size of a predetermined stack or a predetermined updating time for updating the common document file is passed.

According to still another feature of the present disclosure, the engine-pool server transmits an updated common document file to the document edit terminal.

According to still another feature of the present disclosure, the engine-pool server transmits the updated common document file to an additional document edit terminal, when the additional document edit terminal requests sharing the common document file.

According to another aspect of the present disclosure to achieve the above-described objects, there is provided a non-transitory computer-readable recording medium that includes instructions for providing a method of sharing common documents using a dualized server, the instructions are for: providing a common document file to a document edit terminal, receiving edit instructions for editing the common document file from the document edit terminal, storing the edit instructions, which are received until an updating condition for updating the common document file is satisfied, sequentially on an edit instruction list, and updating the common document file on the basis of the common document file and the edit instruction list through an engine for updating the common document file, when the updating condition is satisfied.

The details of other exemplary embodiments are included in the following detailed description and the accompanying drawings.

The present disclosure can provide a method and an apparatus for sharing common documents using a dualized server that can rapidly edit common document shared by a plurality of document edit terminals, using a small amount of resources.

Further, the present disclosure can provide a method and an apparatus for sharing common documents using a dualized server that can quickly provide updated common documents to document edit terminals that additionally share common documents, when common documents are shared by additional document edit terminals.

The effects of the present disclosure are not limited to the aforementioned effects, and other various effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram illustrating a schematic configuration of an apparatus for sharing common documents according to an exemplary embodiment of the present disclosure. Also, the relationships between the apparatus for sharing common documents and a shared server and between the apparatus for sharing common documents and a document edit terminal are included;

FIG. 2 is a diagram illustrating a process of updating a common document file in accordance with a method of sharing common documents using a dualized server according to an exemplary embodiment of the present disclosure;

FIG. 3 is an exemplary diagram illustrating a method of sharing a common document file and receiving and keeping edit instructions in accordance with the method of sharing common documents using a dualized server according to an exemplary embodiment of the present disclosure;

FIG. 4 is an exemplary diagram illustrating a method of sharing a common document with an additional document edit terminal in accordance with the method of sharing common documents using a dualized server according to an exemplary embodiment of the present disclosure; and

FIG. 5 is an exemplary diagram illustrating updating conditions that can be selected in the method of sharing common documents using a dualized server according to an exemplary embodiment of the present disclosure.

### DETAILED DESCRIPTION OF THE PREFERRED EMBODIMENT

Advantages and features of the present disclosure, and methods for accomplishing the same will be more clearly understood from exemplary embodiments described below with reference to the accompanying drawings. However, the present disclosure is not limited to the following exemplary embodiments but may be implemented in various different forms. The exemplary embodiments are provided only to complete disclosure of the present disclosure and to fully provide a person having ordinary skill in the art to which the present disclosure pertains with the category of the disclosure, and the present disclosure will be defined by the appended claims.

The shapes, sizes, ratios, angles, numbers, and the like illustrated in the accompanying drawings for describing the exemplary embodiments of the present disclosure are merely examples, and the present disclosure is not limited thereto. Further, in the following description, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Throughout the whole specification, the same reference numerals denote the same elements.

The features of various embodiments of the present disclosure can be partially or entirely bonded to or combined with each other and can be interlocked and operated in technically various ways as can be fully understood by a person having ordinary skill in the art, and the embodiments can be carried out independently of or in association with each other.

Hereinafter, terminologies used herein are defined.

A document edit terminal stated herein, which is a terminal that can edit an electronic document file, means a terminal that can share electronic document files in a shared server. A shared server is a cloud server that can edit the contents and settings of the electronic document files.

A common document stated herein, which is a document made by collaboration of a plurality of document edit terminals, means an electronic document that document edit terminals share. The common document may mean an electronic document stored in a cloud server that document edit terminals connect with in order to share an electronic document.

A common document file stated herein means a common document itself that is shared by a plurality of document edit terminals and that can be edited, or a path allowing for access to a common document. For example, the common document file may be a common document itself that is transmitted from a shared server such as a cloud server and temporarily kept in a common document sharing device, or a link allowing a document edit terminal to access to a common document.

An edit instruction stated herein is a instruction for editing a common document file shared by document edit terminals. It can be created by a document edit terminal editing a common document file and transmitted to a common document sharing device. For example, the edit instruction may include ‘delete’ for deleting contents of a common document file and ‘insert’ for inserting object such as pictures.

An edit instruction list stated herein, which is a list receiving edit instructions from a instruction transmission server and sequentially keeping them, means a list that keeps edit instructions received until an updating condition is satisfied.

An additional document edit terminal stated herein means a document edit terminal that additionally requires a shared server to share a common document file, after a document edit terminal shares a common document file through the shared server.

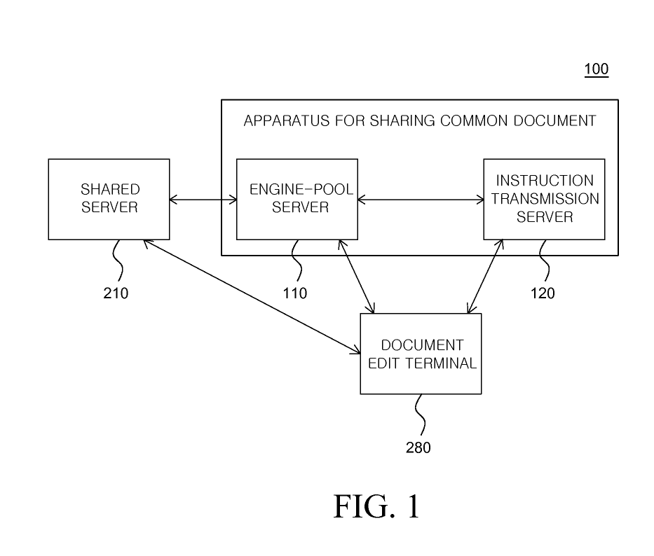

FIG. 1 is a diagram illustrating a schematic configuration of an apparatus for sharing common documents according to an exemplary embodiment of the present disclosure. Also, the relationship between the apparatus for sharing common documents and a sharing server and between the apparatus for sharing common documents and a document edit terminal is illustrated.

Referring to FIG. 1, an apparatus 100 for sharing common documents includes an engine-pool sever 110 and a instruction transmission server 120.

The engine-pool server 110 includes various engines, and in detail, the various engines may be engines that can execute or edit a common document file. For example, the engine-pool server 110 may include an engine for receiving a common document file, an engine for executing a common document file, or an engine for applying edited things to a common document file. In particular, the engine-pool server 110 includes an engine for updating a common document file.

The instruction transmission server 120 includes instructions received from a document edit terminal 280. In detail, the instruction transmission server 120 receives edit instructions for editing a common document file from the document edit terminal 280. Further, the instruction transmission server 120 keeps the received edit instructions on an edit instruction list. In detail, the instruction transmission sever 120 can temporarily keep edit instructions, which are received until an updating condition for updating a common document file is satisfied, sequentially on the edit instruction list.

Referring to FIG. 1, the apparatus 100 for sharing common documents is connected with a shared server 210 and the document edit terminal 280. In detail, the apparatus 100 for sharing common documents, the shared server 210, and the document edit terminal 280 are connected such that they can communicate with each other or such that the document edit terminal 280 can share and edit a common document file.

The shared server 210, which is a server keeping common document files, can provide a common document file to at least one of the shared server 210 and the document edit terminal 280, when it receives a request for sharing a common document. The shared server 210 can transmit a common document file to the apparatus 100 for sharing common documents and can receive and keep an updated common document file.

The document edit terminal 280 can transmit a request for sharing a common document to the apparatus 100 or the shared server 210 for sharing common documents or can receive and share a common document file. Further, there is one document edit terminal 280 in the above description for convenience, but two or more terminals that share common documents may be provided.

The engine-pool server 110 is connected such that it can communicate with the instruction transmission server 120 and can receive an edit instruction list from the instruction transmission server 120. That is, the apparatus 100 for sharing common documents is dualized into the engine-pool server 110 including common document files and updated common document files and the instruction transmission server 120 transmitting an edit instruction list to the engine-pool server 110.

Accordingly, the apparatus 100 for sharing common documents including a dualized server can improve the problems of a waste of resources from a server. Also, deterioration of the speed and performance of updating common document files which are generated when a common document file is updated every time an edit instruction are received through one server can be improved.

The components of the apparatus 100 for sharing common documents are illustrated as independent parts for the convenience of description, but they may be achieved as one part. Or, one part may be divided into two or more parts in accordance with the way of implementing the components of the apparatus 100.

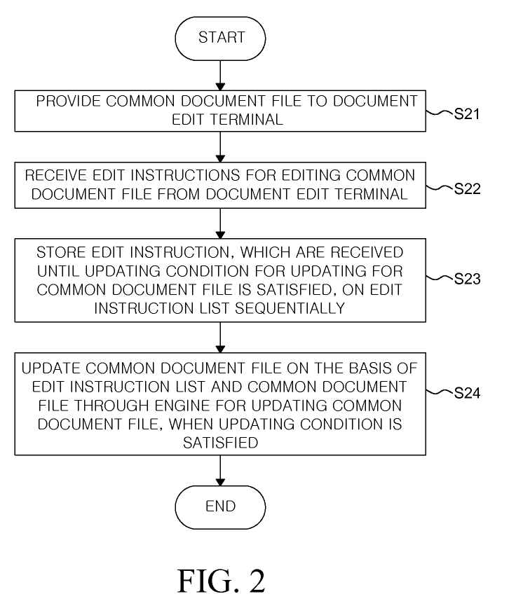

FIG. 2 is a diagram illustrating a process of updating a common document file in accordance with a method of sharing common documents using a dualized server according to an exemplary embodiment of the present disclosure. The following description refers to FIG. 1 for convenience.

A method of sharing common documents using a dualized server according to an exemplary embodiment of the present disclosure is started by the engine-pool server 110 providing a common document file to the document edit terminal 280 (S21).

In detail, the engine-pool server 110 can receive a common document file from the shared server 210 and provide it to the document edit terminal 280. That is, the engine-pool server 110 can function as a medium that transmits a common document file kept in the shared server 210 to the document edit terminal 280. Herein, a common document file in the engine-pool server 110 can be transmitted from the shared server 210 separated from the engine-pool server 110 and temporarily kept in the engine-pool server 110.

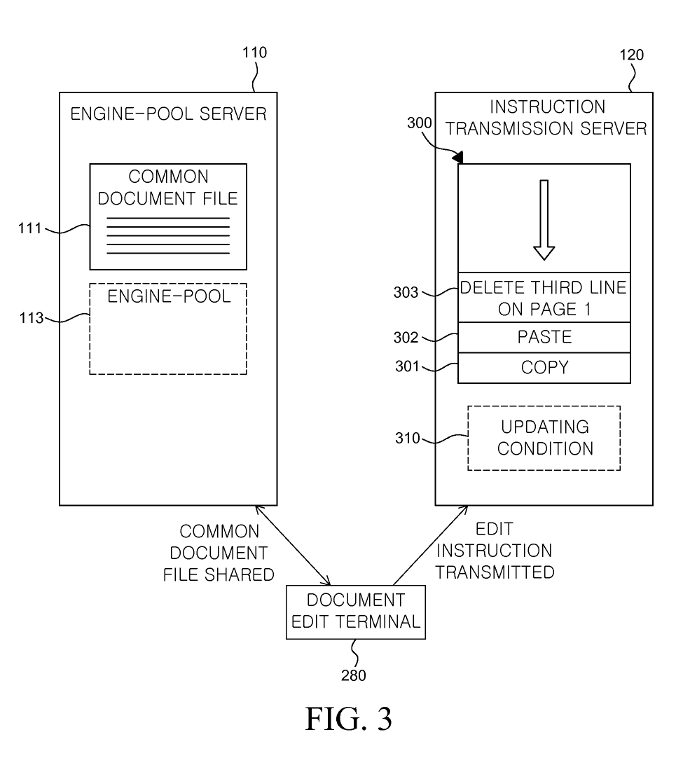

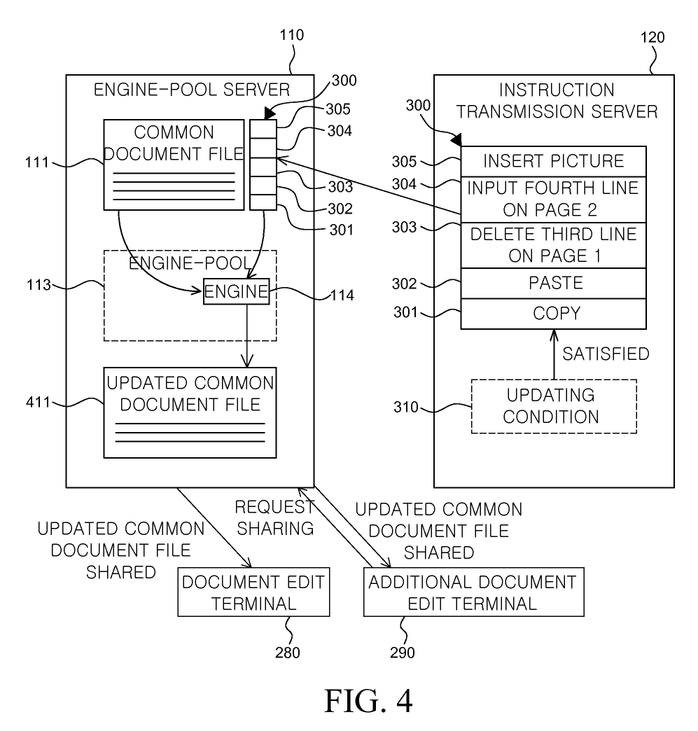

A process of providing a common document file before and after updating the document edit terminal 280 by means of the engine-pool server 110 will be described below with reference to FIGS. 3 and 4.

Next, the instruction transmission server 120 receives an edit instruction for editing a common document file from the document edit terminal 280 (S22). Thereafter, the instruction transmission sever 120 keeps edit instructions, which are received until an updating condition for updating a common document file is satisfied, sequentially on an edit instruction list (S23).

In detail, the instruction transmission server 120 receives edit instructions for editing a common document file from the document edit terminal 280 that shares and edits a common document file. The instruction transmission server 120 includes an edit instruction list. The edit instruction list may be created while edit instructions are transmitted to the instruction transmission server 120, or it may be created in advance and kept in the instruction transmission server 120.

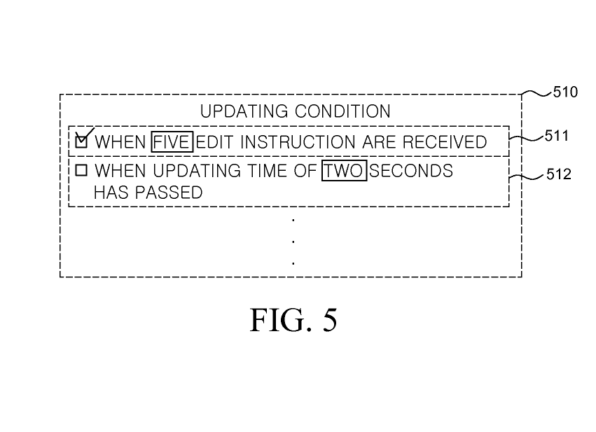

Next, the instruction transmission server 120 sequentially keeps edit instructions transmitted to the instruction transmission server 120 on the edit instruction list. In detail, edit instructions transmitted to the instruction transmission server 120 may be sequentially stacked on the edit instruction list. Further, the instruction transmission server 120 can control the number of edit instructions temporarily kept in the instruction transmission server 120, including updating conditions. Herein, the updating conditions may be directly set in the instruction transmission server 120 or may be transmitted to the instruction transmission server 120 from the engine-pool server 110 or the shared server 210 and kept therein. The updating conditions will be described below with reference to FIG. 5.

Accordingly, the instruction transmission server 120 receives and temporarily keeps edit instructions from the document edit terminal 280 and transmits the edit instruction list to the engine-pool server 110. That is, the instruction transmission server 120 temporarily keeps and transmits edit instructions, so it can be separated in function from the engine-pool server 110 and can efficiently manage the edit instructions.

The process that the instruction transmission server 120 receives an edit instruction and transmits an edit instruction list in accordance with an updating condition will be described below with reference to FIGS. 3 and 4.

Next, when the updating condition for updating a common document file is satisfied, the engine-pool server 110 updates a common document file on the basis of the common document file and the edit instruction list through an engine for updating a common document file (S24).

In detail, when the updating condition for updating a common document file is satisfied, the engine-pool server 110 updates a common document file through an engine therein. In detail, the engine-pool server 110 can update a common document file on the basis of the edit instruction list and the common document file through an idle engine therein.

Therefore, since the engine-pool server 110 updates a common document file using an idle engine of various engines in an engine-pool, it is possible to efficiently use the engines and improve the speed of updating a common document file.

FIG. 3 is an exemplary diagram illustrating a method of sharing a common document file and receiving and keeping edit instructions in accordance with the method of sharing common documents using a dualized server according to an exemplary embodiment of the present disclosure.

Referring to FIG. 3, the engine-pool server 110 includes a common document file 111 and an engine-pool 113. In detail, the engine-pool server 110 temporarily keeps the common document file 111 received from the shared server 210 while the document edit terminal 280 shares and edits the common document file 111. Accordingly, the document edit terminal 280 can share a common document file through the engine-pool server 110. Herein, the engine-pool 113 may include various engines, but the engine for updating a common document file is not activated because the engine-pool server 110 does not receive an edit instruction list 300.

The instruction transmission server 120 includes the edit instruction list 300 and an updating condition 310. In detail, the instruction transmission server 120 receives edit instructions for editing a common document file from the document edit terminal 280 and sequentially keeps the edit instructions, which are received, on the edit instruction list 300. That is, the edit instruction list 300 puts a first edit instruction 301 that has been transmitted first to the instruction transmission server 120 into the lowermost line in the edit instruction list 300, and puts a second edit instruction 302 on the first edit instruction 301 and a third edit instruction 303 on the second edit instruction 302, in the order of the edit instructions transmitted to the instruction transmission server 120. For example, the edit instruction list 300 has a stack structure, in which ‘copy’ that is the first edit instruction 301 is transmitted first to the instruction transmission server 120, ‘paste’ that is the second edit instruction 302 is transmitted to the instruction transmission server 120 after the first edit instruction 301, and ‘delete third line on page 1’ that is the third edit instruction 303 is transmitted to the instruction transmission server 120 after the second edit instruction 302.

Accordingly, sharing a common document file is performed by the engine-pool server 110 and keeping an edit instruction is performed by the instruction transmission server 120, so the document edit terminal 280 can efficiently share a common document file and transmit an edit instruction through a dualized server.

FIG. 4 is an exemplary diagram illustrating a method of sharing a common document with an additional document edit terminal in accordance with the method of sharing common documents using a dualized server according to an exemplary embodiment of the present disclosure. FIG. 4 illustrates updating the common document file 111 when an updating condition is satisfied and the components described above with reference to FIG. 3 are not described below.

Referring to FIG. 4, the instruction transmission server 120 transmits the edit instruction list 300 to the engine-pool server 110, when the updating condition 310 is satisfied. For example, if the updating condition 310 is ‘five edit instructions received’, the instruction transmission server 120 can transmit an edit instruction list 300 to the engine-pool server 110, when a first edit instruction to a fifth edit instruction (301 to 305) are kept on the edit instruction list 300.

Accordingly, the engine-pool server 110 receives the edit instruction list 300 and can update the common document file 111 on the basis of the common document file 111 and the edit instruction list 300 through an engine 114 in the engine-pool 113. In detail, when the edit instruction list 300 is transmitted to the engine-pool serve 110, the engine 114 can create a common document file 411 updated on the basis of the common document file 111 and the edit instruction list 300. Herein, the engine 114 may be one freely selected from idle engines that are not used in the engine-pool 113.

Next, the engine-pool server 110 transmits the updated common document file 411 to the document edit terminal 280. That is, the engine-pool server 110 can receive the edit instruction list 300 transmitted when the updating condition is satisfied. Then, the engine-pool server 110 can transmit the updated common document file 411 to the document edit terminal 280 when the updated common document file 411 is created by the engine 114.

Further, when more document edit terminals request sharing the common document file 111, the engine-pool server 110 can transmit the updated common document file 411 to an additional document edit terminal 290 additionally connected to the engine-pool server 110. That is, the engine-pool server 110 can provide the updated common document file 411, without sharing the common document file 111 before updating. The updated common document file 411 is directly provided to the additional document edit terminal 290 that additionally requests sharing the common document file 111 after the updated common document file 411 is created.

Accordingly, the additional document edit terminal 290 can quickly share the updated common document 411 of which the contents have been most recently edited, upon request when sharing the common document file.

FIG. 5 is an exemplary diagram illustrating updating conditions that can be selected in the method of sharing common documents using a dualized server according to an exemplary embodiment of the present disclosure.

Referring to FIG. 5, an updating condition list 510 may include various updating conditions. In detail, the updating condition list 510 may correspond to a case in which the size of the edit instruction list 300 is equal to or larger than the size of a predetermined stack or a case when a predetermined updating time for updating a common document file has passed. The updating condition list 510 may include a plurality of updating conditions, for example, a first updating condition 511 that is ‘five edit instructions received’, a second updating condition 512 that is ‘updating time of two seconds passed’, and the like.

Only one updating condition may be selected from the updating condition list 510. Further, the updating conditions may be set in detail or changed by a user who sets the updating conditions. For example, only the first updating condition 511 may be selected from the updating condition list 510 and the number of edit instructions in the first updating condition 511 may be set to ‘5’ by a user.

Accordingly, the updating conditions can be set in detail or changed freely by a user, and the apparatus 100 for sharing common documents can efficiently share and edit a common document file. Further, the updated common document file can be rapidly shared, by changing the updating conditions, if necessary.

In the specification, blocks or steps may be portions of a module, a segment, or a code including one or more executable instructions for performing specific logical function(s). Further, it should be noted that functions stated in blocks or steps may not be generated in specific order in some replacing embodiments. For example, two sequential blocks or steps may be substantially simultaneously performed or may be performed in the opposite order in some cases in accordance with the functions.

Steps of an algorism or a method described in association with the embodiments described herein may be achieved directly by hardware and software modules, or a combination of them which are activated by a processor. The software module may stay permanently on a RAM, a flash memory, a ROM, an EPROM, an EEPROM, a register, a hard disc, a detachable disc, a CD-ROM, or other storages known in the art. The storages are coupled to a processor and the processor can read information from the storages and record information in the storages. Alternatively, the storages may be integrated with a processor. The processor and the storages may stay permanently in an ASIC. The ASIC may stay permanently in a user's terminal. Alternatively, the processor and the storages may stay permanently as individual components in a user's terminal.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A method of sharing common documents using a dualized server, the method comprising:
providing a common document file to a document edit terminal;
receiving edit instructions for editing the common document file from the document edit terminal;
storing the edit instructions, which are received until an updating condition for updating the common document file is satisfied, sequentially on an edit instruction list; and
updating the common document file on the basis of the common document file and the edit instruction list through an engine for updating the common document file, when the updating condition is satisfied.

2. The method of claim 1, further comprising receiving the common document file from a shared server.

3. The method of claim 1, wherein the edit instructions include a instruction for changing, deleting, or adding at least a portion of the common document file.

4. The method of claim 1, wherein the updating condition corresponds to a case in which the size of the edit instruction list is equal to or larger than the size of a predetermined stack or a case in which a predetermined updating time for updating the common document file is passed.

5. The method of claim 1, further comprising transmitting an updated common document file to the document edit terminal.

6. The method of claim 5, wherein the transmitting of an updated common document file to the document edit terminal includes transmitting the updated common document file to an additional document edit terminal, when the additional document edit terminal requests sharing the common document file.

7. An apparatus for sharing common documents using a dualized server, comprising:
an engine-pool server including an engine for updating a common document file; and
a instruction transmission server transmitting instructions to the engine-pool server,
wherein the engine-pool server provides the common document file to the document edit terminal and updates the common document file on the basis of the common document file and the edit instruction list through an engine for updating the common document file, when an updating condition for updating the common document file is satisfied, and
the instruction transmission server receives edit instructions for editing the common document file from the document edit terminal and stores the edit instructions, which are received until the updating condition is satisfied, sequentially on an edit instruction list.

8. The apparatus of claim 7, wherein the engine-pool server receives the common document file from a shared server.

9. The apparatus of claim 7, wherein the edit instructions include a instruction for changing, deleting, or adding at least a portion of the common document file.

10. The apparatus of claim 7, wherein the updating condition corresponds to a case in which the size of the edit instruction list is equal to or larger than the size of a predetermined stack or a case in which a predetermined updating time for updating the common document file is passed.

11. The apparatus of claim 7, wherein the engine-pool server transmits an updated common document file to the document edit terminal.

12. The apparatus of claim 11, wherein the engine-pool server transmits the updated common document file to an additional document edit terminal, when the additional document edit terminal requests sharing the common document file.

13. A non-transitory computer-readable recording medium that includes instructions for providing a method of sharing common documents using a dualized server, the instructions are for:
providing a common document file to a document edit terminal,
receiving edit instructions for editing the common document file from the document edit terminal,
storing the edit instructions, which are received until an updating condition for updating the common document file is satisfied, sequentially on an edit instruction list, and
updating the common document file on the basis of the common document file and the edit instruction list through an engine for updating the common document file, when the updating condition is satisfied.
